(19) United States
(12) Patent Application Publication
(10) Pub. No.: US 2005/0077226 A1
(43) Pub. Date: Apr. 14, 2005

(54) Membrane devices using reaction bonded monolith supports

(76) Inventors: Bruce A. Bishop, Arlington, MA (US); Peter J. Hayward, Pinawa (CA); Robert L. Goldsmith, Wayland, MA (US); Garry G. Haacke, Belmont, MA (US)

Correspondence Address: NIELDS & LEMACK, 176 EAST MAIN STREET, SUITE 7, WESTBORO, MA, 01581, US

(21) Appl. No.: 10/685,057

(22) Filed: Oct. 14, 2003

(51) Int. Cl. B01D 59/12

(52) U.S. Cl. 210/321.6; 96/4; 210/510.1; 55/523

(57) ABSTRACT

A membrane device comprised of a porous monolith support formed from a reaction-bonded ceramic powder, fired in an oxygen-free atmosphere, the monolith defining a plurality of passageways extending longitudinally from one end face of the monolith to an opposing end face. A semipermeable membrane suitable for separating a feedstock into permeate and retentate is applied to the passageway walls of said monolith. The semipermeable membrane can be selected from the group of membranes suitable for microfiltration, ultrafiltration, nanofiltration, pervaporation, reverse osmosis, and gas separations.

### FIELD OF THE INVENTION

This invention relates to an improved membrane device based on the use of a multiple passageway monolith support comprised of a reaction-bonded ceramic powder. The support is formed by extrusion, or by other means, of a mixture containing the ceramic powder and a reactive binder precursor powder. On heating in an oxygen-free atmosphere, the precursor powder reacts with a gaseous, liquid or solid reactant to bond the ceramic powder. The resulting monolith is highly permeable to gases and liquids, and is suitable as a support for the semi-permeable membrane used in the membrane device.

### BACKGROUND OF INVENTION

Ceramic Honeycomb Monoliths. Extruded ceramic honeycomb monoliths were developed as catalyst supports for automotive catalytic converters, environmental catalyst supports for fixed site installations, and diesel particulate filters. These monoliths have a multiplicity of passageways that extend from one end face to an opposing end face. The cell structure is formed by an extrusion process, with a cell density as low as 9 cells per square inch (cpsi) to as high as 1400 cpsi. For monoliths with circular cross section, diameters can be as large as 12 inches, or greater. The length of such monoliths in extrusion can be over 6 feet, but is limited by such factors as the available facilities for extrudate handling, uniform extrudate drying and the ability to successfully sinter large extruded parts. Numerous patents exist for such monoliths produced from, for example, cordierite (e.g., Lachman and Lewis in U.S. Pat. No. 3,885,997, and Frost and Holleran in U.S. Pat. No. 3,899,326) and silicon carbide (e.g., Stobbe in U.S. Pat. No. 5,195,319 and U.S. Pat. No. 5,497,620). In general, such monoliths, especially those with larger diameters and longer lengths, are difficult to produce from most ceramic materials. Cordierite has been produced relatively readily because it has a low coefficient of thermal expansion (CTE) of about 2×10⁻⁷/° C. to 1×10⁻⁶/° C. This low CTE minimizes thermal and mechanical stresses during the sintering and cool-down process, allowing sintering of such monoliths and avoiding fracture during sintering. Recrystallized silicon carbide monoliths with a higher CTE of about 3.5-4×10⁻⁶/° C. have superior thermal and mechanical properties that permit their sintering and cooling without fracturing. First, the relatively high thermal conductivity of silicon carbide (e.g., >5 W/m-K) relieves thermal gradients within the monolith. Second, the relatively high mechanical strength allows greater stress tolerance during sintering and cool-down. Third, and relevant to the subject of this invention, the volume change during sintering is very small, typically about 1-2% shrinkage. This “near net shape” property is important for sintering ceramic bodies in a way that minimizes internal differential stresses during the sintering cycle, thereby reducing the risk of mechanical failure.

In summary, present methods for manufacturing honeycomb-structured monoliths mainly involve extrusion of suitably plastic batch materials through a die, followed by drying and sintering at an appropriate temperature to produce the final monolith. The choice of materials currently available for monolith fabrication is restricted to those that have a low CTE, have a micro-cracked structure to relieve internal stresses, or exhibit negligible (<2-5% linear) shrinkage during sintering, in order to prevent deformation and/or cracking of the monolith during sintering and subsequent cooling. At present, honeycomb-structured monoliths are only commercially available in relatively low CTE materials, such as cordierite, mullite and silicon carbide. Although cordierite and mullite are relatively inexpensive materials, their aqueous chemical durability is inferior to those of most silica-free oxide engineering ceramics. The chemical durability of silicon carbide is significantly greater, but the relatively high fabrication cost associated with sintering at elevated temperatures (>2000° C.) in an inert atmosphere make the use of silicon carbide an expensive proposition for many engineering applications.

Porous Ceramic Monoliths as Membrane Supports. Porous ceramic monoliths are widely used as supports for filter bodies and ceramic membrane filter devices, and the patent art contains descriptions of monoliths produced from many different materials. Perhaps the earliest disclosure was in the French Patent Publication 2,061,933, filed Oct. 3, 1969 by the Commissariat a L'Energie Atomique, which describes a multichannel α-alumina monolith as a support for a α-alumina ultrafiltration membrane. In 1978 Hoover and Roberts (U.S. Pat. No. 4,069,157) described the use of cordierite honeycomb monoliths as supports for dynamically formed membranes. In 1984, Gillot, et al., presented a paper “New Ceramic Filter Media for Cross-Flow Microfiltration and Ultrafiltration” (Filtra 1984 Conference, Oct. 2-4, 1984) that described the use of sintered α-alumina membranes deposited on sintered α-alumina monoliths supports, closely related to the CEA French patent mentioned above. Abe, et al. (U.S. Pat. No. 4,894,160) disclosed the use of clay-bonded α-alumina as a honeycomb monolith support. In 1993 Faber and Hudgins described the use of titania as a monolith membrane support (U.S. Pat. No. 5,223,318). In 1995 Castillon and Laveniere (U.S. Pat. No. 5,415,775) disclosed the use of a mixture of titania α-alumina monoliths as membrane supports. Grangeon and Lescoche describe metal oxide monolith supports containing titania in combination with other metal oxides, especially alumina (U.S. Pat. No. 5,607,586 and U.S. Pat. No. 5,824,220).

In general, porous α-alumina, configured in small-diameter tubular and monolith structures, is the most common material used as a support for ceramic membranes. Such porous α-alumina materials are usually produced by sintering a monodisperse alumina at temperatures of 1600° C. to 1800° C. The use of clay, or other metal oxides, or fine α-alumina reactive binders can reduce the sintering temperature needed.

Large diameter honeycomb monoliths have been used for membrane supports for crossflow membrane devices. For example, the patents of Hoover and Roberts (U.S. Pat. No. 4,069,157), Hoover and Iler (U.S. Pat. No. 4,060,488), Goldsmith (U.S. Pat. No. 4,781,831, U.S. Pat. No. 5,009,781, and U.S. Pat. No. 5,108,601), Faber and Frost (U.S. Pat. No. 5,641,332), Yorita, et al., (U.S. Pat. No. 5,855,781), and Rajnik, et al. U.S. Pat. No. 6,077,436) disclose such devices.

Similar large diameter monoliths have been used as dead end filters, especially for diesel exhaust gas filtration. Early diesel filter devices are described by Outland (U.S. Pat. No. 4,276,071), Higuchi, et al. (U.S. Pat. No. 4,293,357, U.S. Pat. No. 4,340,403 and U.S. Pat. No. 4,364,760), Berg, et al., (U.S. Pat. No. 4,364,761), Pitcher (U.S. Pat. No. 4,329,162 and U.S. Pat. No. 4,417,908), and other extensive patent art.

Monolith structures have been used as membrane supports for dead-end membrane filters in which the monolith passageways are coated with a membrane and the passageway ends are plugged, for example, in an “alternate, adjacent checkerboard pattern” typical of diesel exhaust filters, Goldsmith, et al. (U.S. Pat. No. 5,114,581). These filters can be used for the removal of particulates from a gas or a liquid.

The above large diameter monoliths used as membrane supports have all been conceptual designs or made from ceramic materials (cordierite, mullite or silicon carbide) that can be successfully extruded, dried and sintered in large diameter parts while maintaining mechanical integrity. The decisive disadvantage of many ceramics and ceramic composites formed by such a process is the normally high linear shrinkage that occurs between the green body and the final product, typically in the range of 5% to 15%. This shrinkage is problematic when trying to maintain the shape and dimension of a part. Shrinkage during sintering can lead to differential internal stresses and the formation of cracks and other defects, which can lead to the fracture of large parts during cool down.

Reaction-Bonded Ceramics. An early, excellent overview of “Reaction-Formed Ceramics”, Malcolm E. Washburn and William S. Coblenz, was published in Ceramic Bulletin, Vol. 67, No. 2, 1988 (American Ceramic Society). Reaction-formed (or reaction-bonded) ceramics are those ceramics in which a ceramic powder is bonded during firing by reaction of a binder precursor with a gaseous, liquid or a solid phase reactant. These materials differ from sintered ceramics, which are made with powders that bond together at elevated temperature by mass transfer mechanisms that form necks between contiguous particles, ultimately causing the particles to coalesce. Frequently, such bodies will shrink as grains grow together, and porosity will decrease. A typical sintering process may also involve new phase formation such as the reaction of zircon with alumina to form mullite-zirconia bodies, or talc, clay and silica to form cordierite bodies.

Reaction bonding differs in that it involves reaction of a gas, liquid or solid with a binder precursor in the body, the two reactants combining to bond grains together. This is in contrast to sintered ceramics in which bonding is through grain contacts that grow to become grain boundaries.

Several ceramics can be made by reaction bonding. The most well known is reaction-bonded silicon nitride (RBSN). Silicon oxynitride has also been made by a reaction-bonding mechanism. Much effort has been expended for the development of reaction-bonded alumina (RBAO), and this is summarized in a pending patent application of the assignee of this application (USPTO application Ser. No. 10/097,921, filed Mar. 13, 2002). The field of reaction-bonded ceramics is very broad and covers many ceramics bonded by various phases. An important consideration of reaction bonding is that the conditions of bonding, in particular temperature, are achievable with relatively inexpensive equipment. Specifically, it is desirable that the reaction bonding be accomplished with relatively inexpensive furnaces, such as molybdenum-disilicide-element electric furnaces that can be operated routinely to temperatures of 1,600-1,800° C. under many atmospheres.

Silicon Nitride and Silicon Carbide Bonding with Silicon as the Binder Precursor. Nitride-bonded silicon carbide is commonly produced using a mixture of silicon carbide grain and finely divided (typically <325 mesh) elemental silicon. The mixture can be processed into shapes via a variety of means, such as slip casting, pressing, extrusion, etc. The formed shapes are heated in a nitrogen atmosphere under a variety of conditions. Below the melting point of silicon (1410° C.) primarily α-silicon nitride is formed. Above the melting point, primarily β-silicon nitride is formed. The α-form often is in a whisker shape, while the β-form is more granular. The heating rate and gas composition (addition of hydrogen or ammonia, for example) greatly affect the nitridation reaction. Additional liquid phase constituents and silicon impurities can also affect the nitridation reaction. An excellent review of silicon nitride formation reactions can be found in “Silicon Nitride and Related Materials”, Frank L. Riley, in the Journal of the American Ceramic Society, Vol. 83, No. 2, February 2002.

Gadkaree (U.S. Pat. No. 6,555,032 B2) discloses the forming of silicon-nitride bonded silicon carbide honeycomb bodies, including the claimed essential step of having a water soluble thermoset resin in the extruded batch containing silicon metal and silicon carbide. No suggestion is made of the applicability of such honeycombs for use as membrane supports for membrane devices. The intended use is for diesel exhaust soot filters. Lu, et al., (US Appln 2003/0057581 A1) disclose a process for forming a silicon nitride-bonded silicon carbide honeycomb monolith. The patent includes the claimed essential step of heating the honeycomb monolith to 1450° C. with a hold of 1 hour in Argon. Again, no suggestion was made of the applicability of such honeycombs for use as membrane supports for membrane devices; the intended use is also for diesel exhaust soot filters.

Kerber, et al. (WO 94/08915) disclose the fabrication of refractory silicon carbide molded bodies with silicon nitride and/or silicon oxynitride bonding, produced by adding bentonite to a mixture of silicon carbide and silicon, dry pressing and firing in nitrogen. Use as hot gas filters is mentioned.

Porous reaction-bonded silicon nitride bodies have also been fabricated from mixtures of silicon nitride and silicon powders by firing compacts in a nitrogen rich atmosphere to convert the silicon to silicon nitride, which simultaneously forms strong bonds with the pre-existing silicon nitride grains. An example of this method can be found in the article by R. R. Rao, et al., “Nitride-bonded Silicon Nitride from Slip-cast Si+Si₃N₄ Compacts”, in the Journal of Materials Research, Vol. 17, No. 2, February 2002, pp 386-395. A more common technique for fabrication of porous silicon nitride filters is to mix silicon metal with carbon or another pore former and to nitride the formed body. US Patent Appln 20020043735A1, US Appln 20020053542A1, U.S. Pat. No. 6,565,797 B2, USP Appln 2003/0006518 A1, U.S. Pat. No. 6,593,261 B2, all assigned to Asahi Glass Company Limited, disclose such processes. NGK Insulators, Ltd. (EP 1 298 111 A1), has disclosed nitridation of silicon bodies to make all silicon nitride filters with pore sizes in the 1 to 6 μm range.

Sumitomo Electric Industries, LTD., has patented silicon carbide filled silicon nitride bodies made by nitridation of silicon carbide filled silicon and carbon green compacts (U.S. Pat. No. 5,352,641). Sumitomo Electric (U.S. Pat. No. 5,750,449 and U.S. Pat. No. 5,759,460) has also patented silicon nitride or silicon carbide bodies formed by mixing either the nitride or the carbide powder with a silicon oligomer, forming a body, and calcining in a gas composition capable of converting the oligomer to silicon nitride (nitrogen gas) or silicon carbide (inert gas or vacuum). The bodies are porous with a pore size below 1 μm. These latter patents indicate that it is possible to make a body bonded by either silicon nitride or silicon carbide at a moderate temperature (e.g., <1600° C.) starting with fine silicon metal powder and either silicon carbide or silicon nitride ceramic powders.

Similarly, silicon nitride (or silicon oxynitride) can be used to bond oxide ceramics including, but not limited to, alumina, mullite, zircon, zirconia, titania, magnesia, and mixtures thereof. Examples of silicon nitride bonding of ceramic oxides are disclosed U.S. Pat. No. 4,533,646 and U.S. Pat. No. 5,028,570, both assigned to Dresser Industries, Inc.

Carbothermal Reaction Bonding. A silicon nitride or silicon carbide reaction bond can be accomplished using silica (silicon dioxide) instead of silicon metal. The carbothermal reduction of silica by carbon after heating in a nitrogen/oxygen-free gas or a nitrogen-free/oxygen-free gas leads to the conversion of silica to either silicon nitride, silicon carbide, or silicon nitride/silicon carbide composites. Dunmead, et al. (U.S. Pat. No. 5,525,556, U.S. Pat. No. 5,535,675, and U.S. Pat. No. 5,643,843) disclose such processes to form silicon nitride/silicon carbide composites. Hay, et al. (U.S. Pat. No. 5,004,544) discloses the formation of silicon nitride filtration membrane layers by the carbothermal reduction of silica as well as by silicon nitridation.

SiAlON Reaction Bonding. As described above, silicon nitride bonded silicon carbide (or silicon nitride) can be produced by heating a mixture of silicon powder and silicon carbide (or silicon nitride) grains and firing to temperature usually in the range 1300-1550° C. in nitrogen. SiAlON bonded silicon carbide/silicon nitride ceramics can be formed in a similar way. (See, for example: Zhang et al., “Synthesis of β-SiAlON by Reaction Sintering”, in The American Ceramic Bulletin, August, 2003). Reaction precursors can be chosen from the group of silicon, aluminum, graphite, carbon, silica, α-alumina, and y-alumina. Preferred formation conditions, as found by Zhang et al. used a formulation of 34% y-alumina, 57% silicon, and 9% aluminum, with nitriding in flowing high-purity nitrogen at 1500-1550° C. A detailed description of the SiAlON formation process is also found in the Frank L. Riley paper referenced above.

SiAlON reaction bonding can be used to bond silicon nitride, silicon carbide, alumina, mullite, zircon, and other powders to form porous bodies suitable as membrane supports. Campos-Loriz, et al., (U.S. Pat. No. 5,521,129) disclose a SiAlON-bonded silicon carbide refractory. Blair, et al. (U.S. Pat. No. 4,324,356) disclose a process for using SiAlON bonds to bond silicon nitride surfaces. Vayda (EP0317980A3) discloses SiAlON bonded alumina materials and processes for making same.

### SUMMARY OF THE INVENTION

The present invention is a membrane device based on using large shape honeycomb monoliths as membrane supports. The fabrication of large shape monoliths places severe restrictions on the materials that can be employed, especially with regard to the firing of large strong ceramic bodies that can survive firing and/or retain their shape during firing. This behavior is best achieved by using ceramic materials that have minimum shrinkage upon firing, parts that are characterized as having “near net shape”. Such parts can be produced using a “reaction-bonding” process. The membrane device of the subject invention uses such reaction-bonded ceramics in a porous honeycomb shape, based on various means of reaction bonding of different ceramic powders, all in an oxygen-free atmosphere. The membranes that can be applied to the porous honeycomb monolith support structure include organic and inorganic membranes suitable for membrane processes including microfiltration, ultrafiltration, nanofiltration, reverse osmosis, pervaporation, and gas separations.

It is therefore an object of this invention to provide an improved membrane device based on the use of a multiple-passageway ceramic monolith as a membrane support. The ceramic monolith is formed from reaction-bonded materials in a manner such that the monolith retains a near net shape, on firing in an oxygen-free atmosphere, with firing at temperatures that can be attained in moderate cost furnaces, e.g., electric furnaces with molybdenum disilicide elements that fire up to about 1800° C.

It is a further object of this invention to provide such a membrane device using a large diameter monolith support, and also that the device possesses a large amount of membrane surface area relative to the volume of the device.

It is a further object of this invention to provide such a membrane device using a substrate which has a mean pore size and porosity required to effectively serve as a monolith-based porous support for a pressure driven membrane device and that also possesses good chemical durability.

This invention results from the realization that the fabrication of such membrane device requires a composition of the green monolith that undergoes minimal volume change on sintering, and that this can be accomplished by extruding a monolith that is bonded by a reaction bonding mechanism, selecting precursor powders mixed in a proportion such that the volume change of the green monolith on sintering is controllably small. This invention also results from the realization that certain minimal pore size and porosity properties of the monolith are required for monolith-based composite membrane devices.

This invention features a membrane device comprised of a porous monolith support formed from a reaction-bonded ceramic powder, fired in an oxygen-free atmosphere, the monolith defining a plurality of passageways extending longitudinally from one end face of the monolith to an opposing end face. A semipermeable membrane suitable for separating a feedstock into permeate and retentate is applied to the passageway walls of said monolith. The semipermeable membrane can be selected from the group of membranes suitable for microfiltration, ultrafiltration, nanofiltration, pervaporation, reverse osmosis, and gas separations.

In one embodiment, the shrinkage of the monolith support of the device during firing is less than about five percent.

In another embodiment, the reaction bond material used for the monolith is silicon nitride and the bond can be formed by nitridation of a silicon-containing precursor. The silicon-containing precursor can be selected from silicon, silica, silicon oligomers, or mixtures thereof. For such silicon-nitride-bonded monoliths the ceramic powder can be silicon carbide, silicon nitride, alumina, mullite, zircon, zirconia, titania, magnesia, or mixtures thereof.

In yet another embodiment, the reaction bond material can be silicon carbide and the bond can be formed by carbide formation with a silicon-containing precursor. The silicon-containing precursor can be selected from silicon, silica, silica oligomers, or mixtures thereof. For this device, the ceramic powder can be silicon carbide, silicon nitride, alumina, mullite, zircon, zirconia, titania, magnesia, or mixtures thereof.

For another embodiment, the reaction bond material can be SiAlON and the bond can be formed by nitridation of aluminum- and silicon-containing precursors. For this embodiment, the ceramic powder can be silicon carbide, silicon nitride, alumina, mullite, zircon, zirconia, titania, magnesia, or mixtures thereof.

This invention also features a method for making a membrane device, comprising mixing a ceramic powder and a reactive binder precursor, forming a monolith defining a plurality of passageways extending longitudinally from one end face of the monolith to an opposing end face, drying the monolith to form a green monolith, firing said green monolith in an oxygen-free atmosphere to react the reactive binder precursor with a second gas, liquid or solid reactant to create a reaction-bonded monolith membrane support, cooling said reaction bonded monolith support; and applying a semipermeable membrane to the passageway walls of said monolith support to form a membrane device.

### BRIEF DESCRIPTION OF THE DRAWINGS

FIG. 1 is a schematic drawing of a multiple-passageway monolith substrate;

FIG. 2 is a schematic drawing of a monolith substrate showing a few passageways and illustrating the structure of a membrane coating for a composite membrane filtration device; and

FIG. 3 is a graphical illustration of the firing profile of Example 1.

### DETAILED DESCRIPTION OF THE INVENTION

Other objects, features and advantages will occur from the following description of a preferred embodiment and the accompanying drawing, in which:

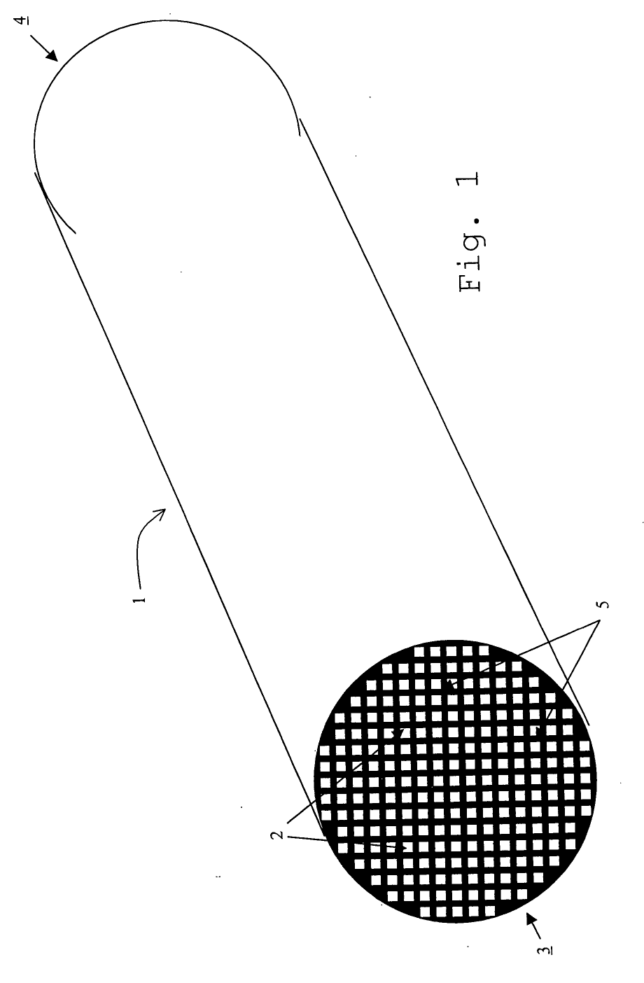

FIG. 1 is a schematic drawing of a multiple-passageway monolith substrate showing a typical structure of the type in accordance with the present invention. A porous monolith substrate 1 has a plurality of passageways 2 that extend from an end face 3 to an opposing end face 4. The walls 5 of the monolith substrate are porous and allow the transport of a fluid, gas or liquid, in a manner suitable for a crossflow filtration or membrane device or a dead end filter or membrane device. The required porosity characteristics of the monolith wall are determined by the specific structure of the filtration device and the flow/pressure drop requirements of the porous material. These requirements are disclosed in the art cited above, and can be achieved by the present invention.

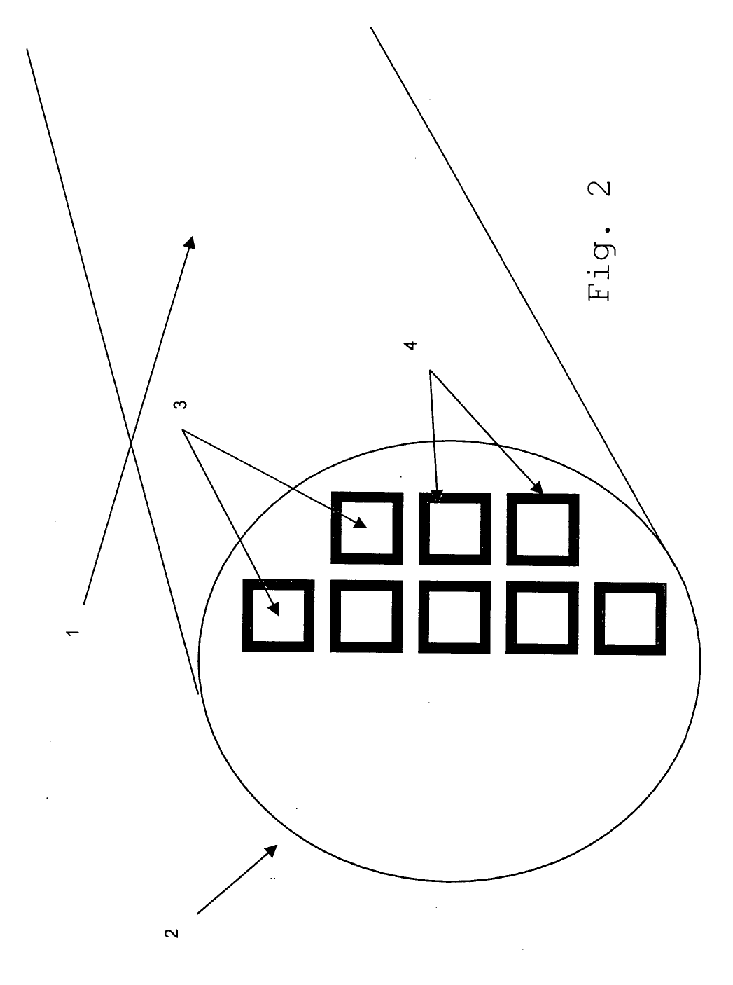

FIG. 2 shows a view of a few passageways of a monolith substrate 1 at one end face 2. The passageways 3 extend from the end face shown to the opposing end face, not shown. A membrane coating 4 is applied to the wall surfaces of the passageways by any of the several means know to one skilled in the art, and this coating typically extends along the full length of the passageways from one end face to the other.

The monolith substrate of FIG. 1 is shown as a circular cylinder. However, the configuration of the structure is not particularly limited; for example, the structure can have a cross section that is round, square or of irregular shape. These latter can be, for example, segments shaped to form a circular cylindrical structure, as disclosed in Stobbe, et al. (U.S. Pat. No. 6,126,833), incorporated herein by reference. A characteristic cross sectional dimension of any such monolith substrate would be its hydraulic diameter, defined as four times the cross sectional area divided by the wetted perimeter.

The present invention relates to the production of membrane devices using highly porous, extruded, reaction-bonded monoliths as membrane supports, such that they can be formed with small to negligible volume change during firing in an oxygen-free atmosphere. Such materials when fabricated into monolith structures exhibit high surface-area to volume ratios, which structures are then modified for use in composite membrane devices such as membrane-coated crossflow membrane devices and membrane-coated dead end devices, as described in the patents and technical papers cited above.

A basis for the invention involves, in particular, the fabrication of a ceramic monolith substrate as a membrane support, the substrate being produced with nil to small volume change on firing. This characteristic is critical to be able to fire successfully large diameter monoliths, that is, to fabricate monolith supports that have minimal internal stresses generated during firing. This near net shape characteristic can be achieved by extrusion, or by the use of other forming means such as injection molding or 3-D printing, of a mixture containing both a relatively coarse ceramic powder and a reactive binder precursor powder that combines with a second gaseous, liquid or solid reactant on firing to bond the monolith. This process is similar to that described in the applicant assignee's pending application USPTO application Ser. No. 10/097,921, filed Mar. 13, 2002, for reaction-bonded alumina monolith materials, fired in air, herein included by reference. The selection of the size of the coarse ceramic powder is the primary determinant of the pore size of the monolith substrate, and selecting the size of the ceramic powder permits the control of the mean pore size of the substrate, for use as a membrane device support, to the desired range of about 1 to 50 μm. In general, it is preferable to use ceramic powders with relatively sharp particle size distributions, as this provides higher porosity, and resulting permeability, than can be achieved by using ceramic powders with a broad particle size distribution. One measure of particle size for many “sized” ceramic powders is the grain size as defined by the FEPA Grit Standard. For the monolith substrates in the present invention, ceramic powders in the range of FEPA grit 1000 (median particle size of 4.5 μm) to FEPA grit 100 (median particle size of 129 μm) can be employed, with a preferred range of FEPA grit 360 (median particle size of 22.8 μm) to FEPA grit 180 (median particle size of 69 μm).

Other preferred characteristics of a monolith support used for the membrane devices include porosity in the range of about 35-50%, a hydraulic diameter of greater than about two inches, and a length greater than about twenty-four inches. The devices of the present invention can have a very high membrane area per unit volume of the device, greater than about 100 ft² membrane area per ft³ device volume.

Membranes that can be applied to the monolith supports can be inorganic or polymeric. The membranes can be suitable for a wide variety of membrane processes, including those commonly identified as microfiltration, ultrafiltration, nanofiltration, reverse osmosis, pervaporation, and gas separations. The membrane processes can include cross-flow processes in which a separate fluid retentate stream is continuously removed from the devices, as well as “dead-end” processes in which matter retained by the membrane builds on the membrane surface and is removed by intermittent backflushing, backwashing, backpulsing or other means, but not as a continuously removed retentate stream.

A preferred ceramic powder for the monolith support is silicon carbide. There are several methods for using a reaction-bonding process to fabricate a strong porous silicon-carbide-based monolith membrane support. A first method is based on the use of silicon metal powder in the extrusion batch. A preferred size range of the silicon metal powder is in the range of about 1 to 5 μm. Smaller size powders are also effective, but in general submicron silicon powders are more difficult to obtain. Larger size silicon powders will be less reactive, may create voids in the sintered body if the silicon is allowed to melt and flow into the monolith body prior to reaction bonding, and may create localized defects.

The thermal profile is very important in determining whether α-silicon nitride or α-silicon nitride will be formed. As described above, one possible thermal profile is to heat under a nitrogen-rich, oxygen-free atmosphere until nitridation starts at 1150-1200° C. when a layer of α-silicon nitride forms on the surface of the silicon particles providing sufficient strength to maintain shape. Continuing to heat slowly will lead to α-silicon nitride whisker growth. Alternatively, heating can proceed quickly to above the silicon melting point of 1410° C., and β-silicon nitride will be preferentially formed. It is noted that the β-silicon nitride phase can be expected to provide a stronger bond and a more permeable nitride-bonded silicon carbide body. The bonding phase is also affected by silicon impurities, silicon particle size, and the presence/absence of oxygen and oxygen getters. For example, silicon impurities, such as iron, can accelerate the nitridation process and favor formation of β-silicon nitride.

Yet other firing alternatives include heating the green monolith to above the silicon melting point in a nitrogen- and oxygen-free environment. This can be achieved by heating in a gas such as helium or argon, or in vacuum. Once the temperature range is reached when β-silicon nitride formation is preferred, nitrogen gas can be introduced.

Another alternative is to perform the reaction bonding in the absence of nitrogen and oxygen and with carbon in the green body, either added as graphite or other form of carbon powder or present from the pyrolysis of an organic binder, to convert the silicon to a silicon carbide bond. The amount of carbon present must equal or exceed the stoichiometric requirement for conversion of silicon to silicon carbide. The conversion of the silicon powder to silicon carbide will occur at a temperature above about 1450° C., with the rate of formation increasing with increasing temperature. Further, in the presence of carbon, regardless of source, processing at temperatures above about 1450-1470° C. in a nitrogen-containing atmosphere will favor formation of a silicon carbide bond over a silicon nitride bond.

The ratio of silicon metal powder to silicon carbide powder should be greater than 1:19 (5 wt % silicon) and less than 1:1 (50 wt % silicon) by weight, in order to achieve strong bonding in the body. A preferred range for the silicon-to-silicon carbide ratio is from about 1:9 (10 wt % silicon) to 1:2 (33 wt % silicon). The wt % is based on the combined weight of silicon plus silicon carbide.

For the nitridation reaction, it is preferable to conduct the reaction in flowing gas. The addition of a hydrogen source, in particular hydrogen, ammonia or methane, is advantageous to act as a scavenger for oxygen, which can be present in the gas phase or as surface oxides on the powders. The presence of a hydrogen containing gas, such as a 4% hydrogen, 96% nitrogen mixture, can also be expected to accelerate the nitridation reaction.

As an alternative to added silicon metal powder, silica can be added in combination with a stoichiometric excess of carbon, as carbon or graphite in as a fine a powder as possible, in combination with silicon carbide refractory powder. Carbon black is especially useful for this purpose. Heating above about 1450° C. in the absence of nitrogen and oxygen results in the carbothermal reduction to silicon carbide as a means of reaction bonding. The amount of silica powder is preferably in the range of 20-40 wt %, based on the combined weights of silica and silica carbide powders used in the original extrusion batch. Adding a hydrogen source to the sintering gas atmosphere can facilitate the carbothermal reduction reaction bonding process.

Further possible sources of silicon for the silicon carbide or silicon nitride reaction bond are silicon oligomers, including, for example, a wide range of polysiloxanes.

Other relatively low cost, chemically durable ceramic powders can be used instead of silicon carbide for reaction bonding with silicon metal powder. These ceramic powders can include, for example, silicon nitride, alumina, mullite, zircon, zirconia, titania, or magnesia.

As described above, SiAlON reaction bonds can be used to form reaction bonded monolith supports. In this case, any of a variety of starting materials can be employed so long as aluminum, silicon and solid oxygen sources are present and the sintering is conducted in a nitrogen-containing, oxygen-free atmosphere.

For extruded monoliths, a variety of organic additives can be employed to facilitate extrusion, including a lubricating agent such as stearic acid. Organic polymeric binders are also employed to impart strength to the extrudates and to facilitate handling of the green body. Such materials could include, typically, methylcellulose, carboxymethylcellulose, or polyvinyl alcohols. The use of lubricants to facilitate extrusion and organic binders to maintain structure of the green body are well known in the art and widely applied in the commercial production of such monoliths.

Since extruded monoliths contain at least one polymeric binder to give strength to the green body after drying, it may be desirable to conduct the initial part of the firing cycle (e.g. to about 600° C.) in an oxygen-containing atmosphere to remove the binder. Subsequent firing is then in an oxygen-free atmosphere. If this oxidative burnout is not used, pyrolysis of the binder can leave a carbonaceous residue that may inhibit the reaction bonding. For any firing condition, however, it is necessary to have a mechanism of intermediate temperature bonding to hold the monolith part together until a temperature is reached at which the intended reaction bonding occurs. Alternative low-temperature binders can include, for example, colloidal silica, alumina, or other colloidal binder or a polymeric silicate. Silica contained in such binders can ultimately be converted, at least in part, to either silicon nitride or silicon carbide.

### EXAMPLE 1

200-gm batches of a mixture containing silicon carbide powder and silicon powder were mixed to press disks for reaction bonding. Table 1 provides the composition of the three batches prepared, with silicon contents increasing from about 10 wt % to 20 wt %.

TABLE 1
Batch Compositions for Pressed Disk Studies

| Material | RBSN-1 | RBSN-2 | RBSN-3 |
|---|---|---|---|
| SiC (ca. 40-50 microns) | 134.38 | 126.91 | 119.45 |
| Si (1-5 micron) | 14.93 | 22.40 | 29.86 |
| Methyl Cellulose | 10.19 | 10.19 | 10.19 |
| Ethanol | 9.79 | 9.79 | 9.79 |
| Stearic Acid | 3.26 | 3.26 | 3.26 |
| Water | 23.00 | 23.00 | 23.00 |
| PVA (10%) | 1.71 | 1.71 | 1.71 |
| Ethylene Glycol | 1.63 | 1.63 | 1.63 |
| Wt. % Si in inorganic fraction (Si + | 10 | 15 | 20 |
| SiC) | | | |

The mixing order of constituents and observations are as follows:
1. A mixture of stearic acid, Si powder, and ethanol was mixed with a second mixture of water, 10% PVA in water, and ethylene glycol, and finally the methylcellulose to give a stiff paste.
2. SiC was then added, stirred in by hand (very difficult, semi-dry mixes), then lightly stirred (or, more likely, agitated) in a Kitchenaid mixer to a series of pressable mixes that stuck together under finger pressure.
3. The powders were bagged and stored overnight to age the methylcellulose.

Three 5-g pellets of each were pressed between 1″ diameter non-porous paper disks in a 1″ die using 1000 psi pressure (≈75 bars pressure). The pellets were dried at 150° C. in a laboratory oven prior to nitriding. Nitriding was performed in a Carbolite SiC tube furnace. After purging with UHP N₂ for 1 hour, nitriding was performed in a 50 cc/min atmosphere of flowing forming gas (N₂, 3.71% H₂). Drying columns packed with magnesium perchlorate were located at the inlet and exit ports of the tube. The following heating/nitriding program was used.
5° C./min ramp from room temperature to 1150° C., 1 hour hold at 1150° C.
5° C./min ramp from 1150 to 1400° C., 3 hour hold at 1400° C.
5° C./min ramp to 1450° C., 1 hour hold at 1450° C.
Cool in shut down furnace.

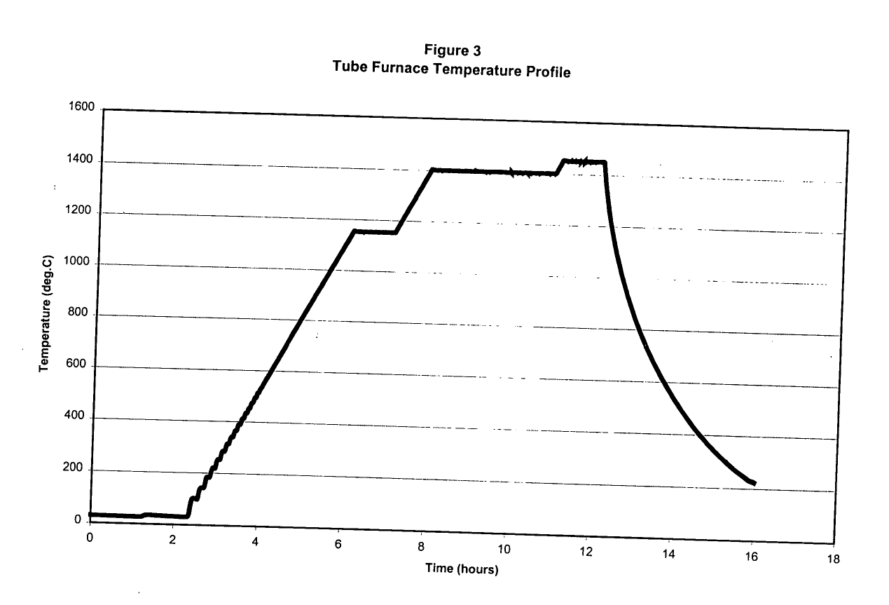

The firing profile is shown FIG. 3. The nitrided pellets increased in mechanical strength from being friable for the 10% silicon content to being quite strong at the 20%

TABLE 2
Weight Changes for Pellets

| | | | | | Final | True wt |
|---|---|---|---|---|---|---|
| RBSN | | | Expected weights | | (true) wt | minus |
| Pellet | Dried | Wt Si in | after: Organic | | After | Expected |
| No. | wt | pellet | burnoff nitriding | | firing | wt |
| 1a | 4.2948 | 0.3897 | 3.8967 | 4.1558 | 4.1711 | 0.0153 |
| 1b | 4.3036 | 0.3904 | 3.9047 | 4.1643 | 4.1685 | 0.0042 |
| 1c | 4.3494 | 0.3946 | 3.9462 | 4.2086 | 4.2155 | 0.0069 |
| 2a | 4.2496 | 0.5785 | 3.8557 | 4.2403 | 4.2564 | 0.0161 |
| 2b | 4.3908 | 0.5977 | 3.9838 | 4.3812 | 4.3948 | 0.0136 |
| 2c | 4.2521 | 0.5788 | 3.8579 | 4.2428 | 4.2477 | 0.0049 |
| 3a | 4.3116 | 0.7824 | 3.9119 | 4.4321 | 4.4414 | 0.0093 |
| 3b | 4.2051 | 0.7630 | 3.8153 | 4.3226 | 4.3163 | −0.0063 |
| 3c | 4.3073 | 0.7816 | 3.9080 | 4.4277 | 4.4271 | −0.0006 |

level silicon content. Weight changes for the pellets of each composition are shown in Table 2.

The weight changes correspond to essentially complete conversion of the silicon to a silicon nitride binder. The generally slightly higher than expected weight increase is attributed to a small residual of carbon from methylcellulose pyrolysis.

### EXAMPLE 2

Coarse silicon carbide powder (2,188 g of ANSI grade SiC (280) from ElectroAbrasives) was combined with fine silicon carbide (548 g of UF-10 from H.C. Starck) and methylcellulose. This dry mixture was sieved through a coarse mesh sieve and stirred for 20 minutes in a 30-quart Hobart mixer.

Stearic acid (150.0 g) was dissolved in warm ethanol (320.0 g). Ethylene glycol (75.0 g) and polyvinyl alcohol (78.5 g of 10% by weight aqueous solution) were mixed into 1108.0 g of water. The stearic acid/ethanol solution was added to the water/ethylene glycol/polyvinyl alcohol solution with vigorous stirring. This solution was stirred with a high-speed mixer until all lumps were broken up.

The liquid components were added slowly to the dry components while mixing in the Hobart mixer. The entire batch was mixed until it took on a clay-like consistency (˜15 minutes). The batch as prepared above was fed into a single auger extruder to produce five billets, approximately 250 mm long by 40 mm wide. These billets were sealed in a polyethylene bag overnight to cure.

The billets were extruded into a 2.625″ monolith with 2 mm×2 mm cells and dried slowly for about 150 hours. The extruded component was weighed periodically and was considered dry when its mass remained constant.

The mass, length and diameter of a small section of the extrudate were measured prior to firing in a Carbolite tube furnace. The firing profile started with binder burn out in air ramping at 1° C./minute to 475° C. and then at 3° C./minute to 500° C. with a soak time of 60 minutes. The purge gas was switched to 3% H₂/Ar at the beginning of the 60 minute soak period. The temperature was then ramped at 5° C./minute to 975° C. at which point the purge gas was switched to pure Ar and the ramp continued to 1100° C. with a soak of 20 minutes. The temperature was then ramped at 2.5° C./minute to 1450 C. After a 60-minute soak the 2.5° C./minute ramp raised the temperature to 1500° C. where the purge gas was switched to 3% H₂₁N₂ and the soak time was 6 hours. The cool down ramp started at 2.5° C./minute to 1450° C. where the purge gas was switched back to 3% H₂/Ar with a soak time of 60 minutes. The final cool down ramp was 3.3° C./minute in Ar.

The sintering shrinkage was found to be 0.61% in the length and 0.56% in the diameter. The open porosity, as determined by water uptake, was found to be 44.9%. On the basis of a scratch test, the fired material was very hard, comparable to the hardness of similar recrystallized silicon carbide monolith materials made with the same coarse SiC and possessing similar porosity. Based on change in mass of the piece, the extent of nitridation was estimated to be high, ca. 90+%.

Although specific features of the invention are described in various embodiments, this is for convenience only as each feature may be combined with any or all of the other features in accordance with the invention. Other embodiments will occur to those skilled in the art and are within the scope of the following claims:

1. A membrane device comprised of:
a porous monolith support formed from a reaction-bonded ceramic powder, fired in an oxygen-free atmosphere, the monolith defining a plurality of passageways, having passageway walls, extending longitudinally from one end face of the monolith to an opposing end face; and
a semipermeable membrane suitable for separating a feedstock into permeate and retentate applied to the passageway walls.

2. The device of claim 1 in which the semipermeable membrane is selected from the group of membranes suitable for microfiltration, ultrafiltration, nanofiltration, pervaporation, reverse osmosis, and gas separations.

3. The device of claim 1 in which the shrinkage of the monolith during firing is less than about five percent.

4. The device of claim 1 in which the reaction bond material is silicon nitride and the bond is formed by nitridation of a silicon-containing precursor.

5. The device of claim 4 in which the silicon-containing precursor is selected from the group of silicon, silica, silicon oligomers, or mixtures thereof.

6. The device of claim 4 in which the ceramic powder is selected from the group of silicon carbide, silicon nitride, alumina, mullite, zircon, zirconia, titania, magnesia, and mixtures thereof.

7. The device of claim 1 in which the reaction bond material is silicon carbide and the bond is formed by carbide formation with a silicon-containing precursor.

8. The device of claim 7 in which the silicon-containing precursor is selected from the group of silicon, silica, silica oligomers, or mixtures thereof.

9. The device of claim 7 in which the ceramic powder is selected from the group of silicon carbide, silicon nitride, alumina, mullite, zircon, zirconia, titania, magnesia, and mixtures thereof.

10. The device of claim 1 in which the reaction bond material is SiAlON and the bond is formed by nitridation of aluminum and silicon containing precursors.

11. The device of claim 10 in which the ceramic powder is selected from the group of silicon carbide, silicon nitride, alumina, mullite, zircon, zirconia, titania, magnesia, and mixtures thereof.

12. A method for making a membrane device, comprising
making a mixture containing a ceramic powder and a reactive binder precursor; forming a monolith defining a plurality of passageways, having passageway walls, extending longitudinally from one end face of the monolith to an opposing end face;
drying said monolith to form a green monolith;
firing said green monolith in an oxygen-free atmosphere to react the reactive binder precursor with a gas, liquid or solid reactant to create a reaction bonded monolith membrane support;
cooling said reaction bonded monolith support; and
applying a semipermeable membrane to the passageway walls of said monolith support to form a membrane device.
